(19) United States
(12) Patent Application Publication
(10) Pub. No.: US 2015/0308154 A1
(43) Pub. Date: Oct. 29, 2015

(54) FLAT CYLINDER-TYPE LOCKING DEVICE

(71) Applicant: Meir AVGANIM, Moshav Gealiya (IL)

(72) Inventor: Meir AVGANIM, Moshav Gealiya (IL)

(21) Appl. No.: 13/505,492

(22) PCT Filed: Jun. 5, 2011
(86) PCT No.: PCT/IL2011/000438

§ 371 Date: Jul. 17, 2012

(30) Foreign Application Priority Data
Jun. 28, 2010 (IL) 206659

(51) Int. Cl. E05B 29/00

(52) U.S. Cl. CPC E05B 29/0006; E05B 29/0033

(57) ABSTRACT

A key operated locking device (10) comprising a lock casing (12;14) and a lock-block (18) slidably supported between first (26) and second (28) walls. The lock-block (18) is displaceable between locked and unlocked positions by first and second keys (20;20′). A series of flat members (404-413) extending side-by-side are slidably positioned within the lock-block. Each flat member comprises a cut-out (404′-413′) through which the first and second keys (20; 20′) may pass. Series of first (101-113) and second (201-213) cavities are formed respectively in the first (26) and the second (28) walls. By passing the first key (20) through the cut-outs (404′-413′), the flat members (404-413) become cleared out of their respective cavities and the lock-block is enabled to slide into locked position by the first key. Releasing the lock-block is attained by the second key (20′).

### FIELD OF THE INVENTION

The present invention generally relates to locking devices and in particular to notched (“YALE”-type) key-operated so called “cylinder” locking mechanisms.

### BACKGROUND OF THE INVENTION

The characteristic feature of cylinder locks is the use of a rotatably mounted plug or rotor. In the locked position, a number of pin tumblers of different lengths, bisected into upper and lower segments, are seated in suitable bores formed in the rotor casing (“stator”), and constantly pressed by springs to become seated within bores formed in the rotor, thereby preventing the latter from rotating. When a suitable key is inserted into the lock, the lower segments of all pin tumblers are displaced by exactly the correct distance to bring their bisection line flush with the interface between the rotor and the stator. Once this particular position is reached, the rotor becomes free to rotate when the key is turned. The cylinder actuates a door locking bolt so that the door can be opened. If a wrong key is inserted, not all or any of the lower tumbler segments will reach the correct position, and rotation the rotor will remain prevented.

One of the limitations of the conventional cylinder locks resides in that a relatively large space is requested (depending on the diameter of the cylinder). Hence, a larer mounting bore must be opened through a door or the like hinged, closable part of a structure. It is therefore a prime object of the invention to provide a cylinder-type-lock—though not based on a rotatable cylinder—for reducing to a minimum its space requirement.

It is a further object of the invention to provide a cylinder-type lock of an elongated, relatively thin prismatic shape.

It is a still further object of the invention to replace the pin-tumblers of the conventional cylinder locks by flat, plate-like members.

The locking and unlocking of the device is achieved by a linear, rather than a rotatable movement.

### SUMMARY OF THE INVENTION

Provided according to the invention is a key operated locking device comprising a lock casing and a lock-block slidably supported within the lock casing by at-least first and second walls extending alongside thereof. The lock-block is displaceable between an unlocked position and a locked position. Displacing the lock-block from the unlocked position to the locked position is enabled by a first key. Displacing the lock-block from the locked position to the unlocked position is enabled by a second key. A series of flat members, distanced from each other and extending side-by-side are provided within the lock-block in a direction crossing its displacement direction. Each flat member comprises a first free end, a second free end, and a cut-out through which the said first and second keys may pass while inserted into the lock-block. A complementary first and second series of cavities are formed respectively in said first and second walls, in alignment with the respective series of the flat members so that the first ends thereof may become inserted into, or cleared out from the first cavities. The second ends of the flat members may become inserted into, or cleared out, from the second cavities. A series of springs are provided constantly applying on each flat member a force causing the first end to rest within the respective first series of cavities. The arrangement being such that by passing the first key through the cut-outs of the flat members, both the first and the second ends of the flat members become cleared out of their respective first and second cavities and the lock block is enabled to slide from the unlocked position into the locked position, and by passing the second key through the cut-outs of the flat members both the first and the second ends of the flat members become cleared out of their respective first and second cavities and the lock-block is enabled to slide from the locked position into the unlocked position. Means are provided for arresting the lock block at the end of the sliding from the unlocked to the locked position and for releasing the lock block from the locked position by insertion of the second key.

### BRIEF DESCRIPTION OF THE DRAWINGS

These and additional constructional features and advantages of the invention will become more clearly understood in the light of the following description of a preferred embodiment thereof, given by way of example only, with reference to the attached drawings, wherein—

FIG. 1 is a schematic elevation of locking device casing in the open or unlocked position, with a key partly inserted, according to a preferred embodiment of the present invention;

FIG. 2 is a view taken along line II-II of FIG. 1;

FIG. 3 is a view taken along line III-III of FIG. 2, namely after removal of the casing cover;

FIG. 4 is a sectional view taken along line IV-IV of FIG. 3;

FIG. 5 is a sectional view taken along line V-V of FIG. 4;

FIG. 6 is a view taken along line VI-VI of FIG. 5;

FIG. 7 is a view taken along line VII-VII of FIG. 5;

FIG. 8 is similar to FIG. 5 but with a key partly inserted into the reciprocable, spring urged, locking block;

FIG. 9 is similar to FIG. 8 but with the key further inserted;

FIG. 10 is similar to FIG. 9 but with the key fully inserted;

FIG. 11 is shows the locked position of the lock device after the locking block having been pushed home by the key;

FIG. 12 is a sectional view taken along line XII-XII of FIG. 11;

FIG. 13 is similar to FIG. 11 but with the key removed, completing the locking of the locking device;

FIG. 14 is a cross-sectional view taken along line XIV-XIV of FIG. 13;

FIG. 15 is a cross-sectional view taken along line XV-XV of FIG. 13;

FIG. 16 is a cross-sectional view taken along line XVI-XVI of FIG. 9;

FIG. 17 is a cross-sectional view taken along line XVII-XVII of FIG. 9;

FIG. 18 is a cross-sectional view taken along line XVIII-XVIII of FIG. 9;

FIG. 19 is a cross-sectional view taken along line XIX-XIX of FIG. 10;

FIG. 20 is a cross-sectional view taken along line XX-XX of FIG. 10;

FIG. 21 is a cross-sectional view taken along line XXI-XXI of FIG. 11;

FIG. 22 is a cross-sectional view taken along line XXII-XXII of FIG. 11;

FIG. 23 is a cross-sectional view taken along line XXIII-XXIII of FIG. 13;

FIG. 24 is similar to 13 but with a different key (or the same key in inverted position) fully inserted into the locking block;

FIG. 25 is a cross-sectional view taken along line XXV-XXV of FIG. 24; and

FIG. 26 shows the locking device released from the locked position into the unlocked position.

### DETAILED DESCRIPTION OF THE PREFERRED EMBODIMENT

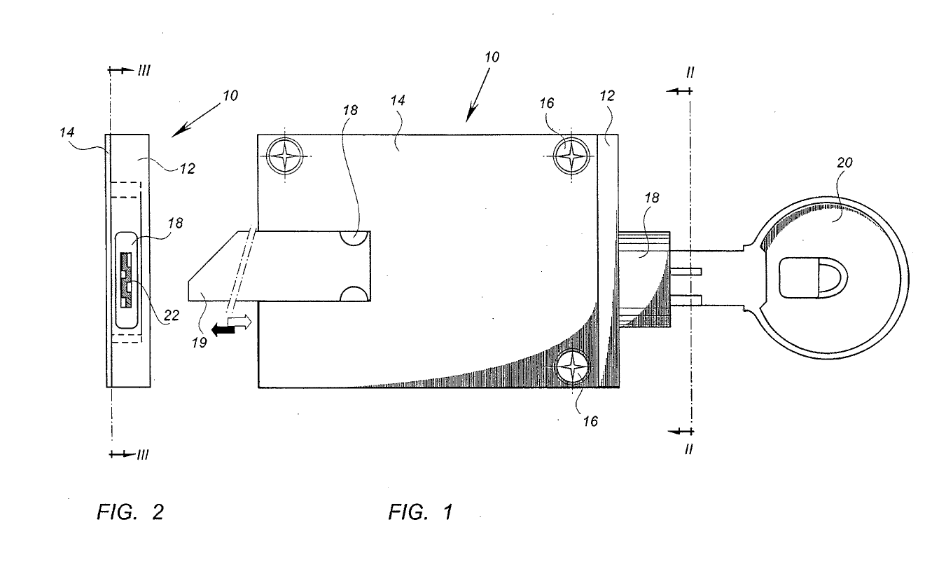

In FIGS. 1 and 2 there is depicted flat, YALE-type key-operated locking device generally designated 10 as seen from outside in its unlocked position. It comprises a base casing member 12 with cover 14 (mounted by screws 16), accommodating a solid, prismatic reciprocally movable locking block 18 partly projecting from the base casing member 12. A key 20 is insertable into and retractable from lock-block 18 via key-way 22. Bar 19 represents schematically the throwable operator of the device that may be coupled by any suitable means to a door or the like locking bolt (not shown).

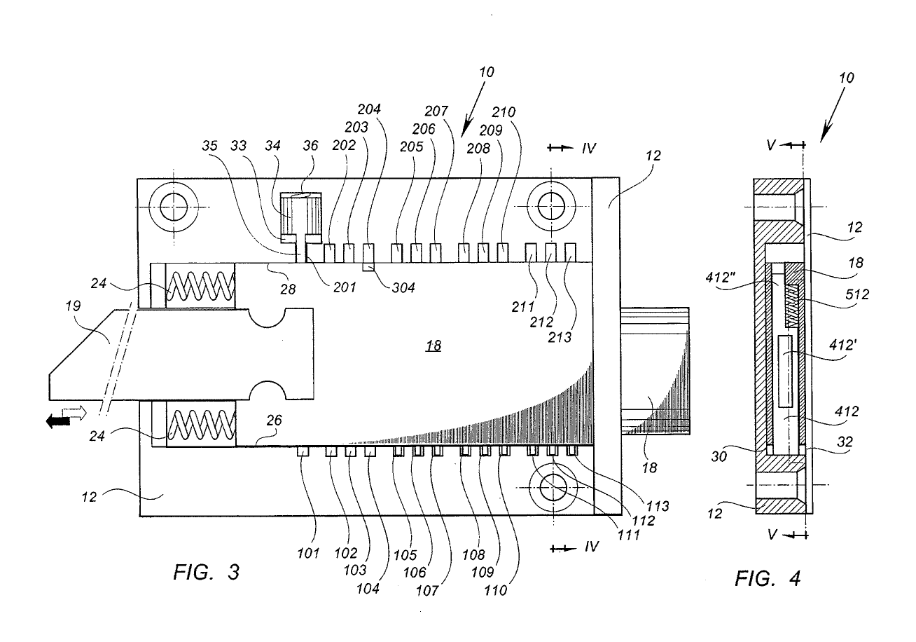

Further revieled by FIGS. 3 and 4 are return coil springs 24 constantly urging the lock-block 18 (with bar 19) in the unlocking direction.

The lock-block 18 is slidably supported between wall portions 26 and 28 at the sides, wall portion 30 at its bottom, and the inside surface 32 of the cover 14 (not shown in FIG. 4). Hence, walls 26 and 28 constitute the interface of the lock casing 12 and the slidable lock-block 18.

A plurality of rectangular, shallow cavities 101, 102, 103, . . . , 113 (in the present example) are formed in the casing 12 along the wall portion 26. The number of cavities (and related components—see bellow) may vary at the designer option, but preferably ranges between 5 and 10.

A plurality of rectangular, shallow cavities 202, 203, 204, . . . 213 are formed in the casing 12 along the wall portion 28, in alignment with their respective cavities 102-113.

Unlike all others, cavity 201 (opposite to cavity 101) is extended (see also FIG. 12) by a widened portion 33 for housing a plug 34 constantly forced by coil spring 36 against the wall 28 interfacing the lock block 18.

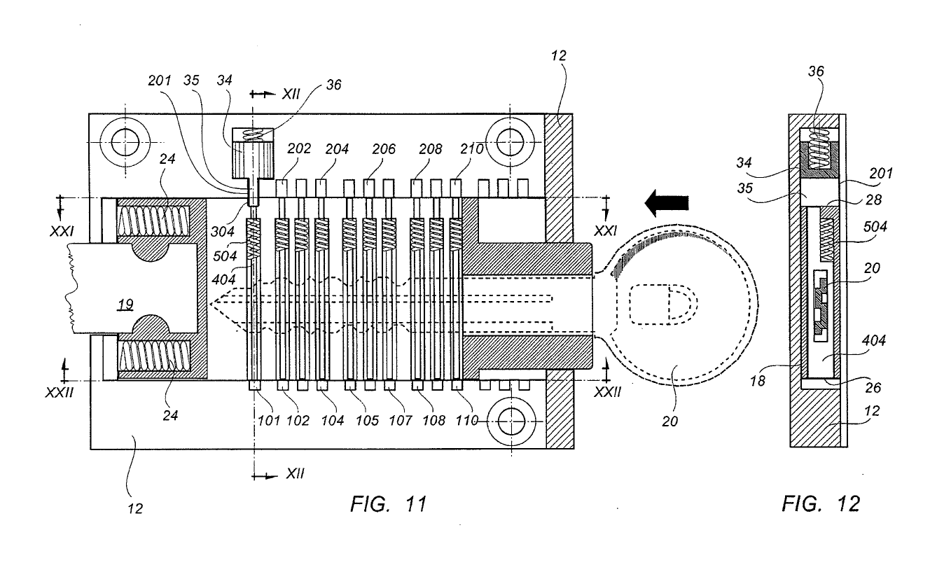

The plug 34 is extended by detent 35 fitting the cavity 201 and allowed to project therefrom as will be described bellow in conjunction with FIG. 11.

A single shallow cavity 304 is formed in the lock block 18 (rather than in casing 12), vis-a-vis the cavity 204 (in the position depicted in FIG. 3).

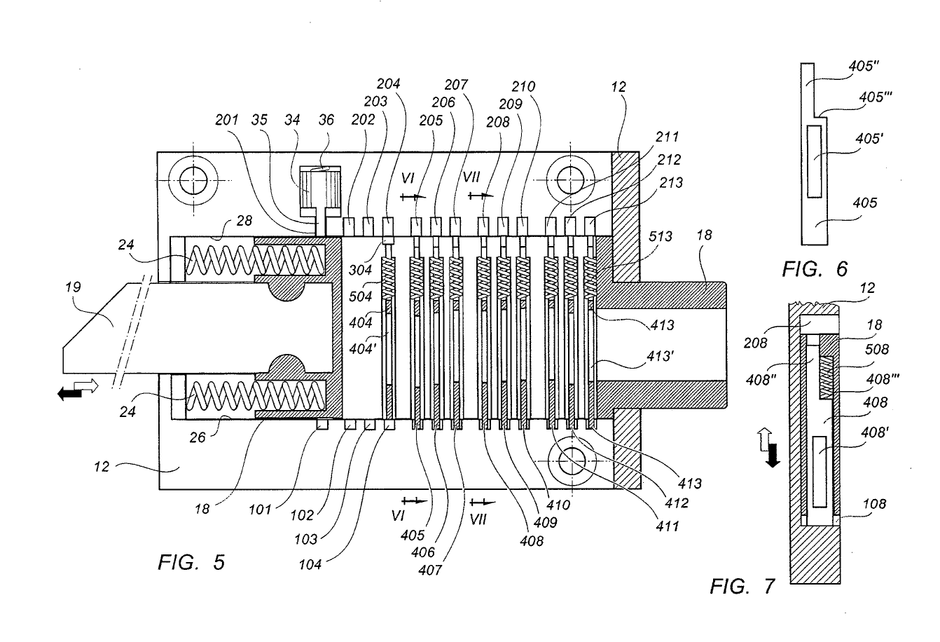

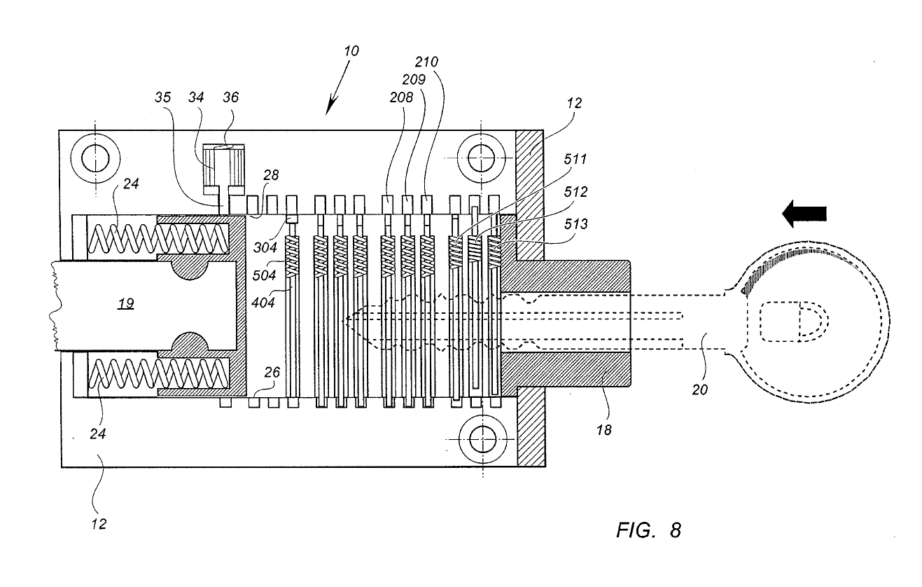

As seen in more detail in FIGS. 5 and 7, there are provided a plurality flat members in the from of plates 404, 405, 406, . . . , 413. The plates may be made of sheet metal or plastics. Each plate is formed with a rectangular window or cut-out (such as 405′ regarding the plate 405 seen in FIG. 6), and with a narrowed portion (such as 405″ in the same regard) thus forming a shoulder (405″′). The length of the plates never exceed the distance between the interface walls 26 and 28; the latitude of each cut-out top line differs one with respect to the other, i.e. defining a different level relative to their bottom end.

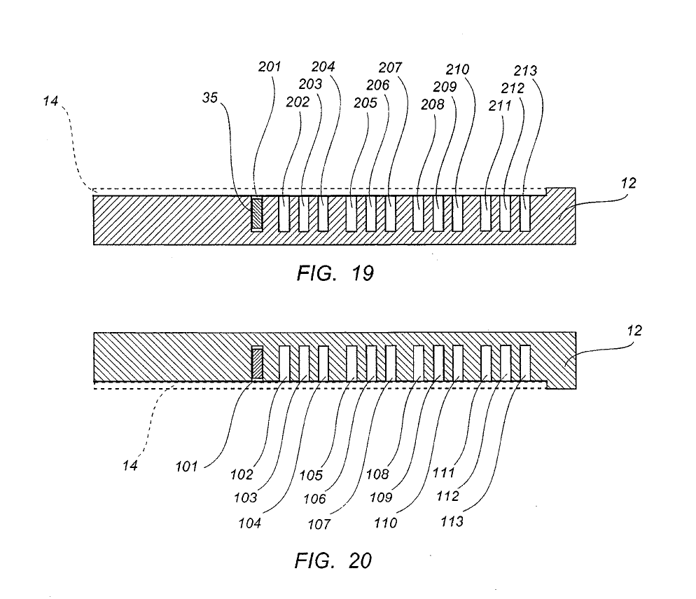

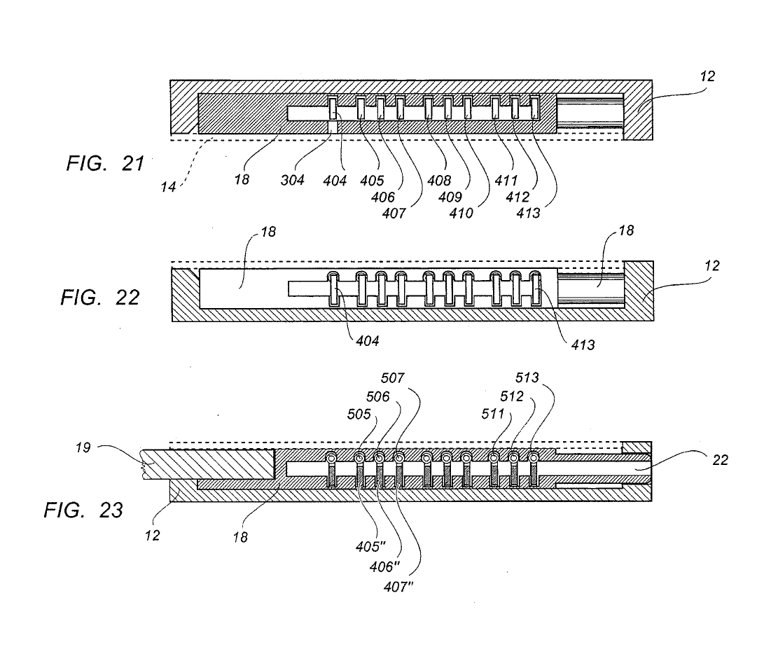

Plates 404 to 413 are normally seated in recesses 104-113 by their bottom parts, respectively, enabling however a limited up and down movement, each against the force of respective coil springs 504-513 compressed between the shoulders 404″′-413′″ all as best seen in FIGS. 7 and 19-23 (but for the locked position—see bellow).

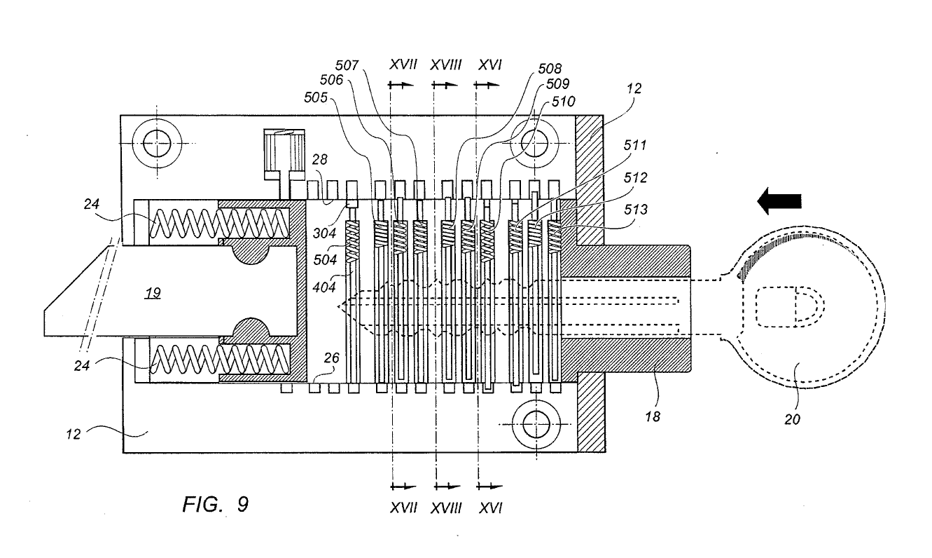

Referring now to FIGS. 8 to 11, key 20 is of YALE-type, namely formed with a series of tips and notches, adapted, when inserted into the key-way of a conventional cylinder lock, to alternately push and relieve the series of pins (of various lengths) until all pins are arranged in a position allowing the cylinder rotor to rotate.

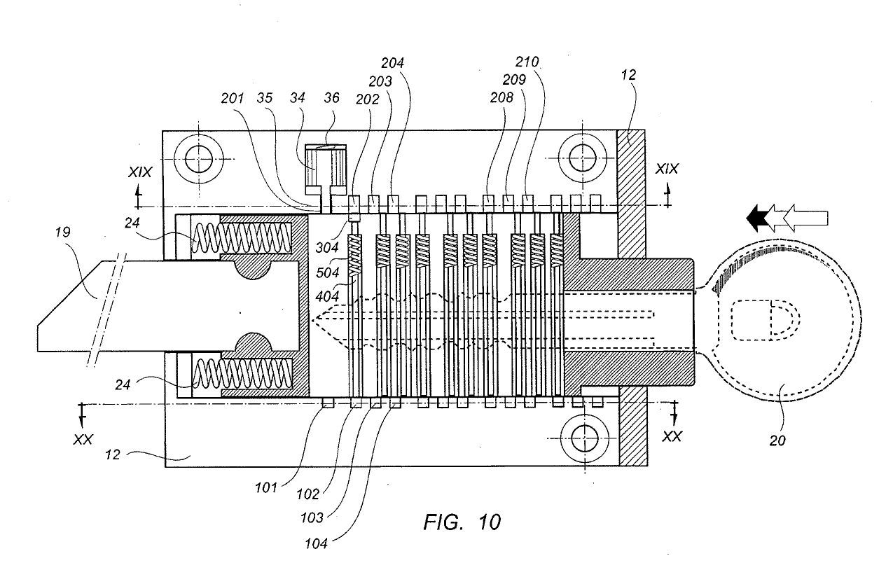

Likewise, the key 20, when passed through the cut-outs of the flat members in friction contact with the upper side of each cut-out, causes the respective flat member to move up-and down (namely into and out of the respective bottoms (“100”) and top (“200”) cavities until, ultimately (FIG. 10), all flat members are held in an intermediate position wherein they are cleared out both from bottom and top cavities. At this particular point, the lock-block is relieved and enabled, under continued pushing movement of the key, to move in unison therewith, against the force of the springs 24, into the locked position shown in FIG. 11. The bar 19 is in its extracted, operative position. Simultaneously, the detent 35, under the load of the spring 36, enters the cavity 304 and blocks is the recoil of the lock-block 18 back into the unlocked position.

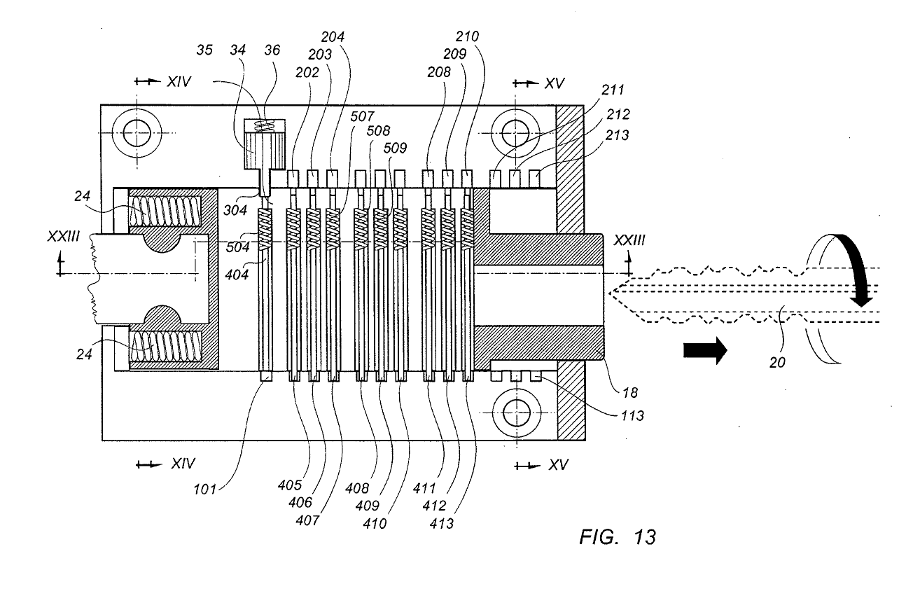

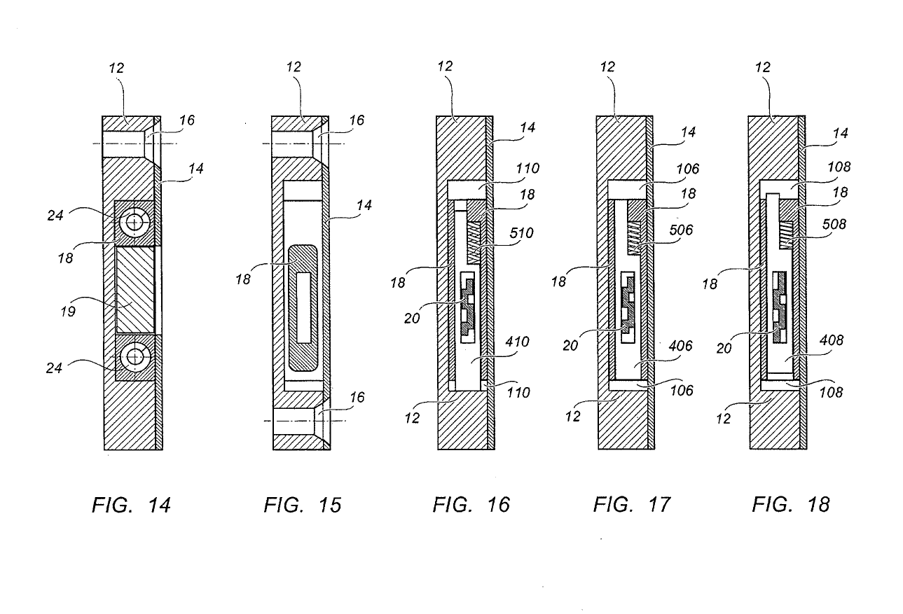

Extracting the key 20 will cause all flat-members to resume their initial position, namely nested in their respective cavities “100” as shown in FIG. 13.

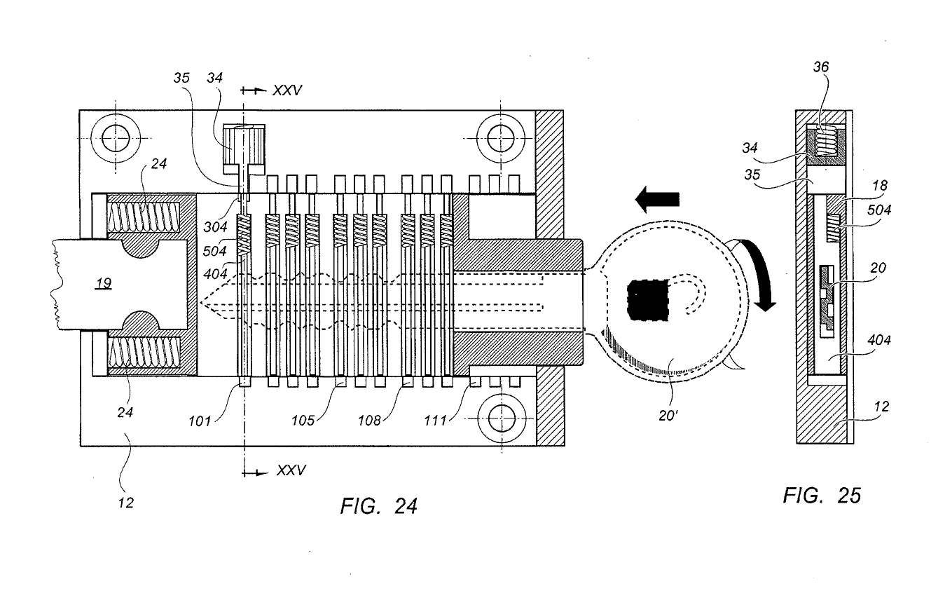

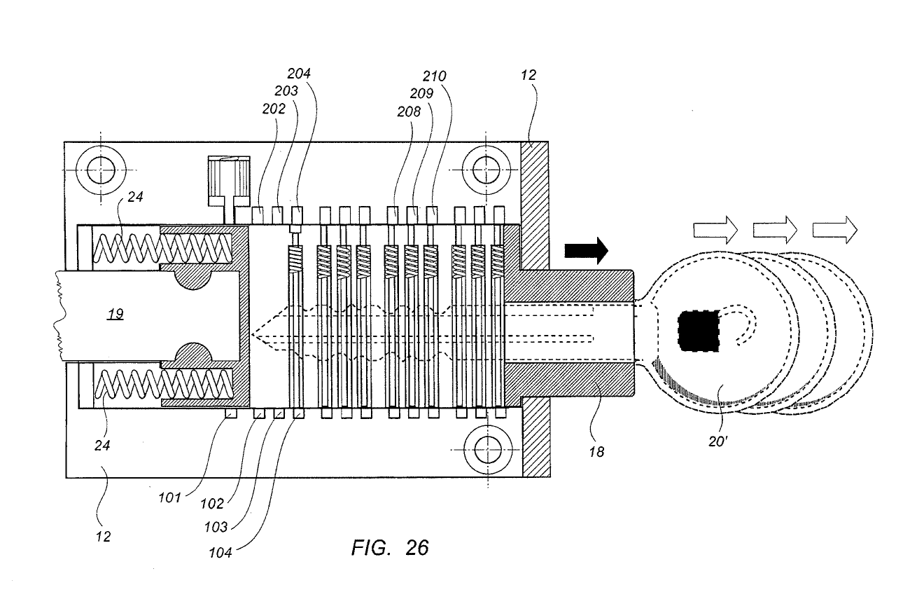

The arrangement of the tips-and-notches of a second key 20′ (or the same key but inverted as depicted in FIG. 24) is identical to the first key 20 but for the first tip, namely the one which operates the flat member 404; it is of a height sufficient to lift the flat member 404 slightly beyond the interface plane 28, thereby clearing the detent 35 from the cavity 304 formerly arresting the lock block 18. Once relieved, the lock block 18, along with the key 20′ that is no longer pushed by the user, will recoil back to the unlocked position—see FIG. 26 and back to FIG. 1.

The invention thus offers a cylinder-type lock maintaining all the well-established advantages of the ordinary cylinder locks, (e.g. a vast number of combinations) but of a size considerably smaller and which is much less expensive to produce (no high-precision requirements).

Those skilled in the art to which this invention pertains will readily appreciate that numerous changes, variations and modifications can be effectuated without departing from the scope of the invention as defined in and by the appendent claims.

What is claimed is:

1. A key operated locking device comprising:
a lock casing;
a lock-block slidably supported within the lock casing by at least first and second walls extending alongside thereof, the lock-block being displaceable between an unlocked position and a locked position, whereby displacing the lock-block from the unlocked position to the locked position is enabled by a first key and displacing the lock-block from the locked position to the unlocked position is enabled by a second key;
a series of flat members, distanced from each other and extending side-by-side within the lock-block in a direction crossing the displacement direction thereof, each flat member comprising—
a first free end,
a second free end, and
a cut-out through which the said first and second keys may pass while inserted into the lock-block;
a complementary first and second series of cavities formed respectively in said first and second walls, in alignment with the respective series of the flat members so that the first ends thereof may become inserted into or cleared out from the first cavities, and the second ends thereof may become inserted into or cleared out from the second cavities;
a series of springs constantly applying on each flat member a force causing the first end to rest within the respective first series of cavities;
the arrangement being such that by passing the first key through the cut-outs of the flat members, both the first and the second ends of the flat members become cleared out of their respective first and second cavities and the lock block is enabled to slide from the unlocked position into the locked position, and by passing the second key through the cut-outs of the flat members both the first and the second ends of the flat members become cleared out of their respective first and second cavities and the lock-block is enabled to slide from the locked position into the unlocked position;
means for arresting the lock block at the end of the sliding from the unlocked to the locked position; and
means for releasing the lock block from the locked position by insertion of the second key.

2. The locking device as claimed in claim 1 wherein the lock-block is of an elongated, prismatic shape.

3. The locking device as claimed in claim 2 wherein each of the flat members further comprises an integrally formed shoulder supporting the said series of springs.

4. The locking device as claimed in claim 3 wherein said arresting means comprise a spring loaded detent adapted to become inserted into a cavity formed in the lock-block towards the end of its displacement to the locking position.

5. The locking device as claimed in claim 4 wherein said releasing means comprise one of said flat-members.

6. The locking device as claimed in claim 1 wherein the number of flat member and associated first and second cavities ranges between 5 and 10.
